(19) United States
(12) Patent Application Publication
(10) Pub. No.: US 2026/0314594 A1
(43) Pub. Date: Oct. 15, 2026

(54) METHODS OF ENHANCING POLLEN VIABILITY OF PLANTS

(71) Applicant: ACADEMIA SINICA, Taipei City (TW)

(72) Inventors: Guang-Yuh JAUH, Taoyuan (TW); Chih-Chung YEN, Kaohsiung (TW); Sheau-Shyang CHEN, Taipei (TW)

(73) Assignee: ACADEMIA SINICA, Taipei City (TW)

(21) Appl. No.: 19/100,388

(22) PCT Filed: Aug. 1, 2023
(86) PCT No.: PCT/US2023/029207

§ 371 Date: Jan. 31, 2025

Related U.S. Application Data
(60) Provisional application No. 63/394,069, filed on Aug. 1, 2022.

(51) Int. Cl. A01N 37/46; A01P 15/00

(52) U.S. Cl. CPC A01N 37/46; A01P 15/00

(57) ABSTRACT

Disclosed is a method for enhancing the pollen viability of plants. In particular, the method of the present invention comprises treating pollen grains of a flowering plant with an effective amount of the compound Formula (I).

### RELATED APPLICATIONS

This application claims the benefit of U.S. provisional application No. 63/394,069, filed Aug. 1, 2022, under 35 U.S.C. § 119, the entire content of which is incorporated herein by reference.

### TECHNOLOGY FIELD

The present invention relates to a method for enhancing the pollen viability of plants. In particular, the method of the present invention comprises rescuing the gradually lost viability of pollen after storage or heat damage by treating them with an effective amount of the compound Formula I.

### BACKGROUND OF THE INVENTION

Seeds and grains are a staple food supply worldwide, and their production results from the successful double fertilization of gametophytes in flowering plants. Pollen germination and tube growth are initial processes for successful double fertilization. After landing on the stigmatic surface, the dehydrated pollen grain intensively interacts with and receives signals from the female stigma to trigger pollen hydration, pollen tube emergence, and growth. Pollen activity and longevity are important factors for successful fertilization and seed set.

In agriculture, intra- and interspecific pollination events are used to improve cultivar production, but asynchronous flowering frequently disturbs successful pollination between parental species. Also, pollen preservation is always challenging because pollen gradually loses its viability under natural and storage conditions. Therefore, preservation and restoration of pollen viability are critical issues for crops with a long-life cycle or non-synchronized flowering patterns (Mesnoua et al., 2018; Du et al., 2019). Various approaches to preserve pollen viability have been developed to overcome different flowering time challenges or separate growing locations of cultivated germplasm lines, facilitate superior germplasm conservation, and help in supplementary pollination used in diverse breeding programs in vegetable crops. For example, low-temperature storage, such as −20° C., is the easiest and most common method to preserve pollen viability; nevertheless, the pollen grain still gradually loses its activity even under low-temperature storage. In addition, extreme weather, such as high- or low-temperatures, is a critical unfavorable factor in pollen sexual reproduction.

There is still a need to provide an approach to enhance the pollen viability of plants, particularly for those with low viability in nature or those with decreased viability due to storage or heat damage.

### SUMMARY OF THE INVENTION

The present invention is based on the finding that a compound of Formula I can stimulate pollen viability of plants, including promoting pollen germination and pollen tube growth, particularly for those with low viability in nature or those with decreased viability due to storage or heat damage.

Therefore, the present invention provides a method to promote the pollen viability of plants by treating pollen grains with a compound of Formula I

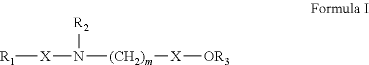

wherein
R₁, R₂, and R₃ are individually hydrogen, an alkyl group, an alkenyl group, an alkynyl group, an aryl group, a carboxyl group, or a linear or branched hydrocarbon chain containing one or more hydroxyl groups;

X is —(C═O)—, and
m is an integer from 1 to 12.

In some embodiments, R₁ is a linear or branched hydrocarbon chain containing one or more hydroxyl groups; R₂ and R₃ are individually hydrogen, an alkyl group, an alkenyl group, an alkynyl group, and an aryl group.

In some embodiments, R₁ is represented by —CHOH-L-CH₂OH, wherein L is an alkylene group with a linear or branched chain.

In some embodiments, L is —(CRₐR_{b})ₙ—, in which n is an integer from 1 to 12, and each of Rₐ and R_{b} is individually hydrogen or an alkyl group

In some embodiments, R₁ is represented by the Formula Ia

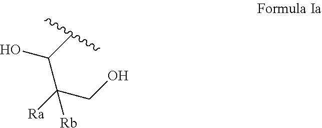

wherein Rₐ and R_{b} are individually hydrogen or an alkyl group.

In some embodiments, the compound is represented by Formula (1)

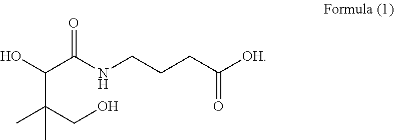 [SMILES: CC(C)(CO)C(O)C(=O)NCCCC(=O)O]

Specifically, the compound of the present invention includes enantiomers (S configuration or R configuration). Examples of enantiomers include

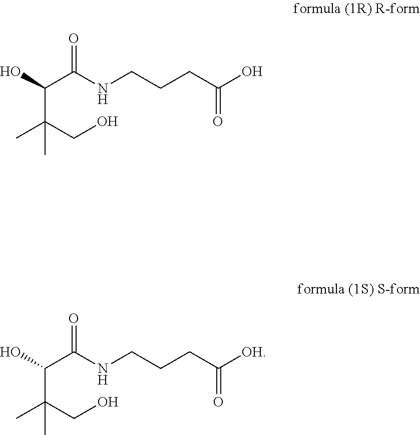 [SMILES: CC(C)(CO)[C@@H](O)C(=O)NCCCC(=O)O ; CC(C)(CO)[C@H](O)C(=O)NCCCC(=O)O]

In some embodiments, the compound of Formula I is present in the composition (concentration) ranging from 1 to 2,000 ppm.

In some embodiments, the composition further comprises an osmotic component, e.g., a sugar, sugar alcohol, and/or polyethylene glycol; minerals, e.g., calcium, potassium, boron, copper, and magnesium; a buffer component, and water.

In specific examples, the composition comprises 1 to 2,000 ppm of the compound of Formula I, and 0.5-20 mM CaCl₂), 0.1-5 mM H₃BO₃, 0.9-20 mM KNO₃, 1-5 mM Ca(NO₃)₂·4H₂O, 0.5-5 mM MgSO₄·7H₂O or KCl, and/or 3-20% sucrose or 2-20% PEG 4000; and/or 5-20 mM MES, 10-40 μM CuSO₄ and/or 1-20 mM MgSO₄.

In some embodiments, the composition is an aqueous or a powdered composition.

In some embodiments, the pollen grains are cultured in the aqueous composition.

In some embodiments, the pollen grains are subjected to storage or heat damage before the treatment with the composition.

In some embodiments, the pollen grains are cultured in the aqueous composition at a temperature of 25 to 28° C.

In some embodiments, the pollen grains are cultured in the aqueous composition at a temperature of 10 to 20° C.

In some embodiments, the method of the present invention is effective in promoting pollen germination and pollen tube growth.

In some embodiments, the flowering plant is selected from the group consisting of rice, wheat, barley, oat, corn, Arabidopsis, cabbage, tomato, cucumber, pumpkin, tobacco, cotton, sugar beet, chrysanthemum, lily, rose, and tulip.

The present invention also discloses a compound of Formula I as described herein for use in enhancing the pollen viability of a flowering plant. Further disclosed is the use of a compound of Formula I as described herein for manufacturing a composition for enhancing the pollen viability of a flowering plant. Also disclosed is a composition comprising a compound of Formula I as described herein and an excipient where the compound is present in an amount effective in enhancing the pollen viability of a flowering plant.

The details of one or more embodiments of the invention are outlined in the description below. Other features or advantages of the present invention will be apparent from the following detailed description of several embodiments and the appending claims.

### BRIEF DESCRIPTION OF THE DRAWINGS

The preceding summary and detailed description of the invention will be better understood when read in conjunction with the appended drawings. To illustrate the invention, there are shown in the drawings embodiments that are presently preferred. It should be understood, however, that the invention is not limited to the precise arrangements and instrumentalities shown.

In the drawings:

FIGS. 1A-1E show that Easter Lily (Lilium longiflorum Thunb. cv White Heaven) stigma exudate (SE) can boost pollen germination in vitro. (FIG. 1A) The scheme of SE is secreted from the lily stigma indicated by the black arrow. White Heaven is a SE-rich variety of L. longiflorum used in this study for SE collection. (FIG. 1B) Manner of SE collection. (FIG. 1C) The morphology of lily pollen germinated in a germination medium (GM) for 2 hours. (FIG. 1D) The morphology of elongating lily pollen tubes in GM with 10% SE for 2 hours. (FIG. 1E) Quantitative analyses of the germination rates of various pollen grains after different storage periods (1 week, 3 months, and 4 months) germinated in GM without or with 10% SE for 1 to 3 hours. P-values are according to ANOVA with Tukey's test. Bar presented in (FIG. 1A), (FIG. 1C), and (FIG. 1D) is 1 cm, 200 μm, and 200 μm, respectively.

FIGS. 2A-2D show the strategies and approaches to isolate and purify exudate stimulating-germination component(s) from SE. (FIG. 2A) Determination of solvents used to extract SE. (FIG. 2B) Parallel strategies of isolating exudate stimulating-germination component(s) from SE. Gel filtration column (size-exclusion chromatography) or reversed-phase column (polar/non-polar chromatography) were used to separate the SE and collect various fractions for further pollen germination assays. (FIG. 2C) Fraction number 6, #F6, obtained from both chromatography approaches, showed the highest stimulation effects in pollen germination. (FIG. 2D) Hence, #F6 from the gel filtration or reversed-phase columns was submitted to UPLC MS/MS and nuclear magnetic resonance spectroscopy (NMR) for identification.

FIGS. 3A-3C show how the putative hopantenic acid (HOPA) structure was determined by ultra-performance liquid chromatography-tandem mass spectrometer (UPLC MS/MS) from #F6. (FIG. 3A) Comparison of the total ion chromatogram (TIC) of #F6 and synthetic HOPA. (FIG. 3B) Comparison of MS1 of candidate 1 in #F6 and synthetic HOPA. (FIG. 3C) Comparison of MS2 of candidate 1 in #F6 and synthetic HOPA. Analyses were conducted in positive ionization mode.

FIGS. 4A-4B show the putative hopantenic acid (HOPA) structure identified by nuclear magnetic resonance spectroscopy (NMR) from #F6. (FIG. 4A) 13C NMR spectrum of #F6. (FIG. 4B) ¹H NMR spectra of #F6.

FIGS. 5A-5G demonstrate that synthetic hopantenic acid (HOPA) significantly stimulates Easter lily pollen germination. (FIG. 5A) Molecular structure of HOPA. Easter lily (Lilium longiflorum Thunb. cv ‘White Heaven’) pollen grains germinated in a culture medium containing 0 ppm (part per million) (FIG. 5B), 10 ppm (FIG. 5C), 50 ppm (FIG. 5D), 100 ppm (FIG. 5E) and 200 ppm (FIG. 5F) HOPA at 28° C. for 2 hours and their corresponding germination rates (FIG. 5G). Pollen grains used in this experiment have been stored at 4° C. for one week. Numbers inside the Bars represent the counted germinated pollen divided by the total observed pollen. The numbers on each bar are the magnification of fold-change compared to the mock, which was set as 1. Scale bars=1 mm.

FIGS. 6A-6F show that synthetic hopantenic acid (HOPA) significantly rescued the germination capability of lily pollen after long-time low-temperature storage, and heat damage and promoted pollen germinates at low temperatures. Lily pollen grains stored at 4° C. for 1 day, 2.5 months, and 5 months were cultured in a germination medium with or without 100 ppm HOPA at 28° C. for 2 hours (FIG. 6A) to measure their corresponding germination rates (FIG. 6B). Lily pollen grains stored at 4° C. for one day were pre-treated at 28, 37, and 42° C. for 4 hours, then subjected for germination in a culture medium with or without 100 ppm HOPA at 28° C. for 2 hours (FIG. 6C) to obtain their corresponding germination rates (FIG. 6D). Lily pollen grains germinate in a culture medium with or without 100 ppm HOPA at 28° C. for 3 hours or 18° C. for 3 and 5 hours (FIG. 6E) to obtain their corresponding germination rates (FIG. 6F). Numbers inside the bars are referred to as the magnification of fold-change compared to the mock, which was set as 1. Scale bars=1 mm. The asterisks (B, D, and F) indicate a significant difference at P<0.05 between treatments (with three biological replicates) by ANOVA with Tukey's test.

FIG. 7 shows that synthetic hopantenic acid (HOPA) promotes pollen tube elongation. Lily pollen grains germinated in a culture medium with (▪) or without (▴) 100 ppm HOPA at 28° C. for different time intervals were collected to calculate their growth rates.

FIGS. 8A-8B show synthetic hopantenic acid (HOPA) with its versatile stimulation effects on pollen germination in Nicotiana tabacum and Arabidopsis thaliana (Col-0). Nicotiana tabacum pollen grains germinated in a culture medium without or with 50-1600 ppm HOPA (FIG. 8A) at 25° C. for 1.5 hours to calculate their germination rates. Arabidopsis thaliana pollen grains germinated in a culture medium without or with 200 ppm HOPA (FIG. 8B) at 25° C. for 2.5 hours to calculate their germination rates. Numbers inside the bars are referred to as the magnification of fold-change compared to the mock, which was set as 1. The asterisks (FIGS. 8A-8B) indicate a significant difference at P<0.05 between treatments (with three biological replicates) by ANOVA with Tukey's test.

### DETAILED DESCRIPTION OF THE INVENTION

The following description is merely intended to illustrate various embodiments of the invention. As such, specific embodiments or modifications discussed herein are not to be construed as limitations to the scope of the invention. It will be apparent to one skilled in the art that various changes or equivalents may be made without departing from the scope of the invention.

Specific terms are first defined to provide a clear and ready understanding of the present invention. Additional definitions are set forth throughout the detailed description. Unless specified otherwise, all technical and scientific terms herein have the same meanings as is commonly understood by one skill in the art to which this invention belongs.

As used herein, the singular forms “a”, “an”, and “the” include plural referents unless the context dictates otherwise. Thus, for example, reference to “a component” includes a plurality of such components and equivalents thereof known to those skilled in the art.

As used herein, the term “comprise” or “comprising” is generally used in the sense of include/including, which means permitting the presence of one or more features, ingredients, or components. The term “comprise” or “comprising” encompasses the term “consists” or “consisting of.”

As used herein, the term “about” or “approximately” refers to a degree of acceptable deviation that will be understood by persons of ordinary skill in the art, which may vary to some extent depending on the context in which it is used. In general, “about” or “approximately” may mean a numeric value having a range of +10% around the cited value.

Pollen viability involves the ability of pollen to complete the pollination process, including pollen germination, pollen tube elongation, and delivery of the sperm cells to the embryo sac for double fertilization. After landing on the stigmatic surface, dehydrated pollen grain intensively interacts and receives signals from the female stigma to trigger pollen hydration, germination, pollen tube emergence, and growth. Pollen viability is rapidly lost during storage time or is caused by a harsh situation such as high temperature. Low temperature or dry storage are standard methods used to preserve pollen vitality, but this invention can significantly stimulate/restore low pollen viability caused by the above adverse conditions. Operationally, stored pollen can be pre-germinated in a culture medium with the compound of Formula I (e.g. HOPA) to regain the decreased viability. Various culture media are available for in vitro pollen germination, which generally comprises an osmotic component such as the sugar, sugar alcohol, or polyethylene glycol, the micronutrients such as calcium, potassium, boron, copper, and magnesium; and the buffer component. Then these pre-germinated pollen grains are ready to pollinate onto the stigma of the received plant for artificial pollination.

According to the present invention, the compound of Formula I effectively enhances pollen viability. The compound of Formula I is of the structure as follows.

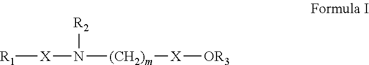

wherein
R₁, R₂, and R₃ are individually hydrogen, an alkyl group, an alkenyl group, an alkynyl group, an aryl group, a carboxyl group, or a linear or branched hydrocarbon chain containing one or more hydroxyl groups;

X is —(C═O)—; and
m is an integer from 1 to 12.

As used herein, the term “alkyl” refers to an aliphatic saturated hydrocarbon chain and includes straight and branched chains. An alkyl group may be a C₁-C₁₂ alkyl such as a C₁-C₁₀ alkyl, a C₁-C₈ alkyl, C₁-C₆ alkyl, C₁-C₄ alkyl and C₁-C₃ alkyl. Examples of alkyl include, but are not limited to, methyl, ethyl, n-propyl, isopropyl, n-butyl, n-pentyl, isobutyl, and the like.

As used herein, the term “alkenyl” refers to an aliphatic unsaturated hydrocarbon chain, including straight and branched chains, having at least one carbon-carbon double bond. An alkenyl group may be a C₂-C₁₂ alkenyl such as a C₂-C₁₀ alkenyl, a C₂-C₈ alkenyl, C₂-C₆ alkenyl, C₂-C₄ alkenyl and C₂-C₃ alkenyl. Examples of alkenyl include but are not limited to vinyl (ethenyl), propenyl, 2-methyl-1-propenyl, 1-butenyl, 2-butenyl, and isobutenyl.

As used herein, the term “alkynyl” refers to an aliphatic unsaturated hydrocarbon chain, including straight and branched chains, having at least one carbon-carbon triple bond. An alkynyl group may be a C₂-C₁₂ alkynyl such as a C₂-C₁₀ alkynyl, a C₂-C₈ alkynyl, C₂-C₆ alkynyl, C₂-C₄ alkynyl and C₂-C₃ alkynyl. Examples of alkynyl include, but are not limited to, ethynyl (acetylenyl), 1-propynyl, 1-butynyl, 2-butynyl, 1-pentynyl, and 1-hexynyl.

As used herein, the term “aryl” refers to a benzene ring or to a benzene ring system fused to one or more benzene or heterocyclyl rings to form, for example, anthracene, phenanthrene, napthalene, or benzodioxin ring systems. Examples of aryl include, but are not limited to phenyl, 2-naphthyl, 1-naphthyl, biphenyl, and 1,4-benzodioxin-6-yl.

As used herein, the term “carboxyl” refers to the group-C(═O) OR, wherein R is selected from the group consisting of hydrogen, alkyl, alkenyl, alkynyl and aryl.

As used herein, the term “alkylene” refers to a divalent aliphatic hydrocarbon group, including straight and branched chains. An alkylene group may be a C₁-C₁₂ alkylene, such as a C₁-C₁₀ alkylene, a C₁-C₈ alkylene, C₁-C₆ alkylene, C₁-C₄ alkylene and C₁-C₃ alkylene. An alkylene group may be a divalent alkylene group substituted by alkyl, where the alkyl is preferably methyl or ethyl, for example, a dimethyl substituted methylene group.

In some embodiments, R₁ is a linear or branched hydrocarbon chain containing one or more hydroxyl groups. In particular embodiments, R₁ is a linear or branched C₁-C₁₂ alkyl substituted by 2 to 5 hydroxyl groups such as 2 hydroxyl groups, 3 hydroxyl groups, 4 hydroxyl groups, or 5 hydroxyl groups.

In some embodiments, R₁ is represented by —CHOH-L-CH₂OH, wherein L is an alkylene group with a linear or branched chain. In particular embodiments, L is represented by —(CRₐR_{b})ₙ—, in which n is an integer from 1 to 12, and each of Rₐ and R_{b} is individually hydrogen or an alkyl group.

In some embodiments, m is an integer of 1, 2, 3, 4, 5, 6, 7, 8, 9, 10, 11 or 12. In some embodiments, m is an integer from 1 to 10 (i.e. 1, 2, 3, 4, 5, 6, 7, 8, 9 or 10). In some embodiments, m is an integer from 1 to 8 (i.e. 1, 2, 3, 4, 5, 6, 7 or 8). In some embodiments, m is an integer from 1 to 6 (i.e. 1, 2, 3, 4, 5 or 6). In some embodiments, m is an integer from 1 to 3 (i.e. 1, 2 or 3).

In some embodiments, n is an integer of 1, 2, 3, 4, 5, 6, 7, 8, 9, 10, 11 or 12. In some embodiments, n is an integer from 1 to 10 (i.e. 1, 2, 3, 4, 5, 6, 7, 8, 9 or 10). In some embodiments, n is an integer from 1 to 8 (i.e. 1, 2, 3, 4, 5, 6, 7 or 8). In some embodiments, n is an integer from 1 to 6 (i.e. 1, 2, 3, 4, 5 or 6). In some embodiments, n is an integer from 1 to 3 (i.e. 1, 2 or 3).

In particular embodiments, R₁ is represented by the Formula Ia

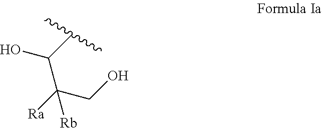

wherein Rₐ and R_{b} are individually hydrogen or an alkyl group.

In one specific example, the compound of the present invention is represented by formula (1)

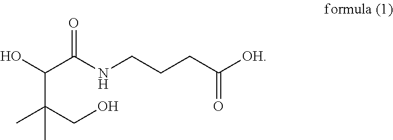 [SMILES: CC(C)(CO)C(O)C(=O)NCCCC(=O)O]

More specifically, the compound of the present invention includes enantiomers (S configuration or R configuration). Examples of enantiomers include

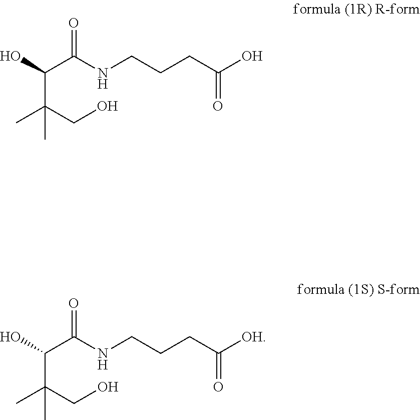 [SMILES: CC(C)(CO)[C@@H](O)C(=O)NCCCC(=O)O ; CC(C)(CO)[C@H](O)C(=O)NCCCC(=O)O]

The compound of Formula I can be chemically synthesized through a variety of methods known in this art, for example, as described in Pharmaceutical Chemistry Journal. 5 (9): 534-536

In use, an effective amount of the compound of the present invention can be formulated with an agriculturally acceptable excipient to form a composition that is to be applied to pollen grains in need. In addition to water, an excipient can be alcohols, mineral or vegetable oils, calcium carbonate, talc, powdered magnesia, gypsum, and diatomaceous earth. In some embodiments, the composition is in the form of an aqueous or a powdered composition. In some embodiments, the composition may be in the form of solutions, emulsions, liquids, oils, water-soluble powders, wettable powders, powders, subtilized granules, granules, aerosols, fumigants, pastes, and the like.

In some embodiments, the compound of the present invention is added into a pollen germination medium. A pollen germination medium, as known in the art, is used for in vitro germination of pollen grains and pollen tube growth. In particular, a pollen germination medium may contain an osmotic component such as dextrose, galactose, glucose, fructose, mannose, ribose, sucrose, glucitol, mannitol, sorbitol, threitol and/or polyethylene glycol (PEG). In addition, several inorganic micronutrients, such as calcium, potassium, boron, copper, magnesium, etc., are essential for proper pollen germination. Further, a buffer component is often used to maintain a constant pH in the medium, such as Trisaminomethane (Tris) and 2-ethanesulfonic acid (MES). The preferred pH is kept around pH 5 to 8. Several factors, such as hormones, vitamins, buffers, proteins, lipids, and enzymes, are sometimes added to increase the pollen germination rate. In the following examples, a pollen germination medium may include (A) 0.5-20 mM CaCl₂), 0.1-5 mM H₃BO₃, 0.9-20 mM KNO₃, 1-5 mM Ca(NO₃)₂·4H₂O, 0.5-5 mM MgSO₄·7H₂O or KCl, and 3-20% sucrose or 2~20% PEG 4000; and/or (B) 5-20 mM MES, 10-40 μM CuSO₄ and/or 1-20 mM MgSO₄. Under particular situations, a pollen germination medium may include (i) 12.7 mM CaCl₂), 1.62 mM H₃BO₃, 9.9 mM KNO₃, and 10% sucrose, pH5.2; (ii) 1 mM CaCl₂), 1 mM KCl, 1.6 mM H₃BO₃, 5% sucrose, 30 μM CuSO₄, 15 mM MES and 12.5% PEG4000, pH 5.9; (iii) 5 mM mM CaCl₂), 1 mM MgSO₄, 5 mM KCl, 0.01% H₃BO₃, 10% sucrose, pH 7.5; (iv) 1.27 mM Ca(NO₃) 2.4H₂O, 0.87 mM MgSO₄₋₇H₂O, 0.99 mM KNO₃, 1.62 mM H₃BO₃, 100 g/L Sucrose pH 7; (v) 1.27 mM CaCl₂), 0.99 mM KNO₃, 0.162 mM H₃BO₃, 100 g/L Sucrose, pH5.2; (vi) 10% (w/v) Sucrose, 15% PEG4000, 50 mg/L H₃BO₃, 300 mg/L Ca(NO₃)₂·4H₂O, 200 mg/L MgSO₄·7H₂O and 100 mg/L KNO₃, PH7.0; or (vii) 15% Sucrose, 0.005% H₃BO₃, 10 mM CaCl₂), 0.05 mM KH₂PO₄, 6% PEG4000, 100 mg/l H₃BO₃, 100 mg/l CaCl₂) 2H₂O, 100 mg/l MgSO₄·7H₂O, and 100 mg/l KNO₃ supplemented with 10~ 30% sucrose, pH 5.7.

As used herein, the phrase “enhancing pollen viability” may indicate that the viability of pollen grains after treatment with the compound of the present invention is at least 5% higher (e.g., 10% higher, 15% higher, 30% higher, 50% higher, 60% higher, 70% higher, 80% higher, 90% higher, 1-fold higher, 2-fold higher, 3-fold higher, 4-fold higher, 5-folder higher, 6-fold higher, 7-fold higher, 8-fold higher, 9-fold higher, 10-fold higher, or above) than the viability of pollen grains of same plant species under the same condition without treatment with the compound of the present invention. Pollen viability includes the capacity of pollen grains to live, germinate, grow, and develop. Pollen viability can be determined by using fluorescein diacetate stain of pollen germination or by examining the pollen tube elongation. In some embodiments, enhancing pollen viability may include restoring or recovering pollen viability when it is decreasing or lost due to long-time storage or heat damage, for example. The level of pollen grain's restored/recovered viability is comparable to or higher than that of pollen grains under normal conditions (such as in a normal situation without heat damage).

As used herein, the term “storage of pollen” may mean that pollen is collected or harvested from flowers and stored for subsequent use, such as in vitro germination and artificial pollination. Pollen may be stored for days (e.g., 1 to 7 days), weeks (e.g., 1 to 4 weeks), months (e.g., 1 to 12 months), or years (e.g., 1 to 3 years). The storage may be carried out at room temperature, e.g., 20-25° C., or at a low temperature below room temperature, e.g., 4° C., −20° C., or −80° C.

As used herein, the term “heat damage” may refer to damage to pollen viability due to a high temperature, such as a temperature higher than a temperature typically suitable for pollen germination (e.g. 25 to 28° C.). In some embodiment, heat damage may occur to pollen under a temperature higher than 30° C., including 31° C., 32° C., 33° C., 34° C., 35° C., 36° C., 37° C., 38° C., 39° C., 40° C., 41° C., 42° C., 43° C., 44° C. or 45° C.

As used herein, the term “effective amount” or the like refers to the amount of an active agent such as the compound of Formula I as described herein, sufficient to achieve a desired biological effect such as enhancing pollen viability. The effective amount may change depending on various reasons, such as plant species or conditions applied for pollen germination/tube growth.

In some embodiments, the compound of Formula I is present in the composition in an amount of from 1 to 2,000 ppm, such as 3 to 2,000 ppm, 5 to 2,000 ppm, 10 to 2,000 ppm, 15 to 2,000 ppm, 20 to 2,000 ppm, 30 to 2,000 ppm, 40 to 2,000 ppm, 50 to 2,000 ppm, 60 to 2,000 ppm, 70 to 2,000 ppm, 80 to 2,000 ppm, 90 to 2,000 ppm, 100 to 2,000 ppm, 120 to 2,000 ppm, 150 to 2,000 ppm, 170 to 2,000 ppm, and 200 to 2,000 ppm. In some embodiments, the compound of Formula I is present in the composition in an amount of 1 to 1,000 ppm, such as 3 to 1,000 ppm, 5 to 1,000 ppm, 10 to 1,000 ppm, 15 to 1,000 ppm, 20 to 1,000 ppm, 30 to 1,000 ppm, 40 to 1,000 ppm, 50 to 1,000 ppm, 60 to 1,000 ppm, 70 to 1,000 ppm, 80 to 1,000 ppm, 90 to 1,000 ppm, 100 to 1,000 ppm, 120 to 1,000 ppm, 150 to 1,000 ppm, 170 to 1,000 ppm, and 200 to 1,000 ppm. In some embodiments, the compound of Formula I is present in the composition in an amount of 1 to 500 ppm, such as 3 to 500 ppm, 5 to 500 ppm, 10 to 500 ppm, 15 to 500 ppm, 20 to 500 ppm, 30 to 500 ppm, 40 to 500 ppm, 50 to 500 ppm, 60 to 500 ppm, 70 to 500 ppm, 80 to 500 ppm, 90 to 500 ppm, 100 to 500 ppm, 120 to 500 ppm, 150 to 500 ppm, 170 to 500 ppm, and 200 to 500 ppm. In some embodiments, the compound of Formula I is present in the composition in an amount of 1 to 300 ppm, such as 3 to 300 ppm, 5 to 300 ppm, 10 to 300 ppm, 15 to 300 ppm, 20 to 300 ppm, 30 to 300 ppm, 40 to 300 ppm, 50 to 300 ppm, 60 to 300 ppm, 70 to 300 ppm, 80 to 300 ppm, 90 to 300 ppm, 100 to 300 ppm, 120 to 300 ppm, 150 to 300 ppm, 170 to 300 ppm, and 200 to 300 ppm. In some embodiments, the compound of Formula I is present in the composition in an amount of about 5 ppm, about 10 ppm, about 25 ppm, about 50 ppm, about 100 ppm, about 150 ppm, about 200 ppm, and about 300 ppm,

According to the present invention, pollen grains are treated with an effective amount of the compound of Formula I or a composition comprising the same to enhance pollen viability. The treatment of pollen grains with the compound of Formula I or a composition comprising the same may include any methods such that pollen grains are exposed to the compound of Formula I, for instance, immersing pollen grains in a solution containing the compound of Formula I, or spraying a solution containing the compound of Formula I to pollen grains.

In some embodiments, pollen grains are cultured in the presence of the compound of Formula I as described herein under suitable conditions. In particular embodiments, pollen grains are incubated in a germination medium containing an adequate amount of the Formula I described herein under conditions allowing for pollen germination and pollen tube growth. In some examples, pollen grains are cultured for 0.5 to 24 hours (e.g., 0.5 h, 1 h, 1.5 h, 2 h, 2.5 h, 3 h, 3.5 h, 4 h, 4.5 h, 5 h, 5.5 h, 6 h, 6.5 h, 7 h, 7.5 h, 8 h, 8.5 h, 9 h, 9.5 h, 10 h, 10.5 h, 11 h, 11.5 h, 12 h, 12.5 h, 13 h, 13.5 h, 14 h, 14.5 h, 15 h, 15.5 h, 16 h, 16.5 h, 17 h, 17.5 h, 18 h, 18.5 h, 19 h, 19.5 h, 20 h, 20.5 h, 21 h, 21.5 h, 22 h, 22.5 h, 23 h, 23.5 h, or 24 h), optionally with shaking. In some embodiments, pollen grains are cultured at a normal temperature typically suitable for pollen germination, such as 25 to 28° C. In some embodiments, pollen grains are cultured at a lower temperature, such as 10 to 20° C.

The compound of the present invention exhibits cross-species effectiveness. Therefore, the method of the present invention applies to a variety of flowing plants. Examples of flowing plants include but are not limited to rice, wheat, barley, oat, corn, Arabidopsis, cabbage, tomato, cucumber, pumpkin, tobacco, cotton, sugar beet, chrysanthemum, lily, rose, and tulip.

The present invention provides enhancement/restoration of pollen viability which is beneficial in a diverse breeding strategy of modern agriculture. In some instances, pollen viability is inherently low or decreased due to storage or heat damage. For example, the maturation of male and female organs of some plant species occurs at different times (dichogamy); therefore, proper pollen preservation is critical before artificial pollination. Also, the increase in atmospheric temperature caused by the greenhouse effect has become a potential risk factor affecting the normal germination of pollen. Low temperature (e.g. cold weather) is another risk factor for pollen germination. The present invention using the compound of Formula I, as described herein achieves enhancement (or restoration) of pollen viability and thus increases successful plant reproduction and food production.

The present invention is further illustrated by the following examples, which are provided for demonstration rather than limitation. In light of the present disclosure, those of skill in the art should appreciate that many changes can be made in the specific embodiments which are disclosed and still obtain a like or similar result without departing from the spirit and scope of the invention.

### Examples

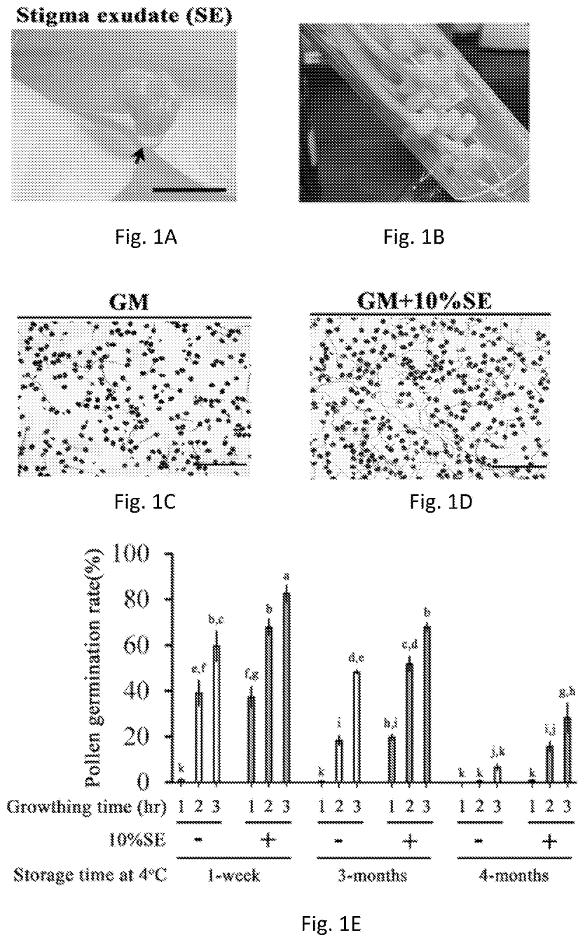

Our preliminary results indeed showed that Easter lily stigma exudate (SE) collected from stigma (FIGS. 1A-1B) significantly stimulates the germination of freshly harvested pollen grains (FIGS. 1C-1D). Moreover, SE efficiently rescues the lost pollen viability after being stored at 4° C. for 3- and 4-months (FIG. 1E). We believe the presence of some uncharacterized natural exudate stimulating-germination component(s) in SE provides an excellent opportunity to solve the crisis of declining longevity of stored pollen in modern agriculture. It can also be an attractive system to explore the underlying mechanism of cell-to-cell communication during plant sexual reproduction.

This study is dedicated to identifying a natural exudate stimulating-germination component(s) from lily SE. We isolated and identified a novel stimulating component named hopantenic acid (HOPA), which can stimulate fresh lily pollen germination and pollen tube elongation. HOPA can rejuvenate long-time storage damaged and heat-damaged decreased pollen germination. Moreover, HOPA effectively stimulated the germination of lily, tobacco, and Arabidopsis pollen. Those results reveal the promising universal function of HOPA in stimulating pollen germination. We believe this innovative technology provides a new approach for breeders to restore pollen activity after heat damage or long-term storage.

### 1. MATERIAL AND METHODS

### 1.1 Plant Material

Pollen and stigma exudate (SE) were collected from more than ten thousand Easter lily (Lilium longiflorum Thunb. cv White Heaven) flowers. After dehydration at room temperature for 4 to 5 days, pollen grains were collected from dehydrated anthers. Pistils were harvested and used for SE collection. In general, 20~50 μL SE collected from a single ‘White Heaven’ pistil will be stored at −20° C. for further usage.

### 1.2 Pollen Germination Conditions

Lily pollen was cultured in a germination medium (GM) containing 12.7 mM CaCl₂), 1.62 mM H₃BO₃, 9.9 mM KNO₃, and 10% sucrose, pH5.2 at 28° C. for 2 hours with shaking at 50 rpm in the dark. Tobacco (Nicotiana tabacum) pollen was germinated in GM containing 1 mM CaCl₂), 1 mM KCl, 1.6 mM H₃BO₃, 5% sucrose, 30 μM CuSO₄, 15 mM MES, and 12.5% PEG4000, pH 5.9 at 25° C. for 2 hours with shaking at 50 rpm in the dark. Arabidopsis (Arabidopsis thaliana, Col-0) pollen was germinated in GM containing 5 mM CaCl₂), 1 mM MgSO₄·5 mM KCl·0.01% H₃BO₃, 10% Sucrose, pH 7.5 at 25° C. for 2 hours with shaking at 50 rpm in the dark. An Olympus BX51 microscope recorded germinating pollen. Pollen germination rate was calculated using the formula below: Pollen germination rate (%)=number of germinated pollen grains per field of view by the total number of pollen grains per field of view X100.

### 1.3 Isolation of Exudate Stimulating-Germination Component(s) by Sephadex LH-20 Column Chromatography

We weighed about 20 g of Sephadex LH-20, saturated fully with 200 mL distilled water, and then transferred carefully to an eluting column (40 cm×1.5 cm). The SE extracts were injected into the column, then eluted with methanol/water (2.5:5) for at least threefold column volume to equilibrate before exposing to the sample.

### 1.4 Isolation of Exudate Stimulating-Germination Component(s) by C18 Reversed-Phase Column Chromatography

The SE extracts were injected into an ACQUITY UPLC (waters)—Orbitrap Elite Mass Spectrometer (Thermo Scientific) equipped with a CSH C18 (2.1×100 mm, Waters). The column temperature was set to 40° C. Eluents A and B were 2% acetonitrile/0.1% formic acid and 100% acetonitrile/0.1% formic acid, respectively. Elution was performed isocratically for 0.4 ml/min at 1% eluent B, then, consecutive linear gradients to 30, 99, 1, and 1% eluent B in 4, 5, 5.01, and 6 min were run.

### 1.5 Ultra-Performance Liquid Chromatography-Tandem Mass Spectrometer (UPLC MS/MS)

Samples were injected into an ACQUITY UPLC (waters)—Orbitrap Elite Mass Spectrometer (Thermo Scientific) equipped with a CSH C18 (2.1×100 mm, Waters). The column temperature was set to 40° C. Eluents A and B were 2% acetonitrile/0.1% formic acid and 100% acetonitrile/0.1% formic acid, respectively. Elution was performed isocratically for 0.4 ml/min at 1% eluent B, then, consecutive linear gradients to 99, 99, 1, and 1% eluent B in 4, 5, 5.01, and 6 min were run.

### 1.6 Nuclear Magnetic Resonance Spectroscopy (NMR)

¹³C and ¹H NMR were acquired on a Bruker AVIII-600 spectrometer (Ettlingen, Germany).

### 1.7 Quantification and Statistical Analysis

ImageJ measured pollen tube length and Western blot band intensity quantification. All P-values were calculated by One-way ANOVA (Analysis Of Variance) and Tukey's post hoc tests with SPSS

### 2. RESULTS

2.1 Isolation and Identification of Exudate Stimulating-Germination Component(s) from SE

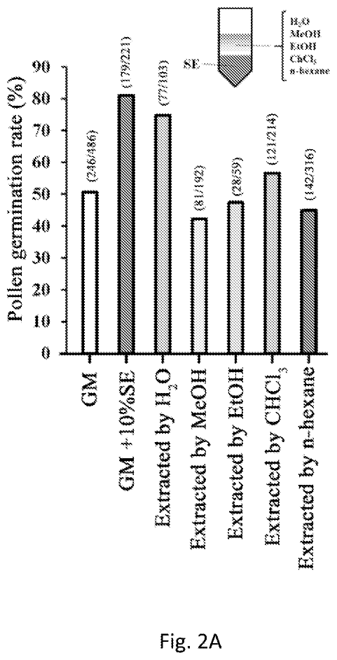

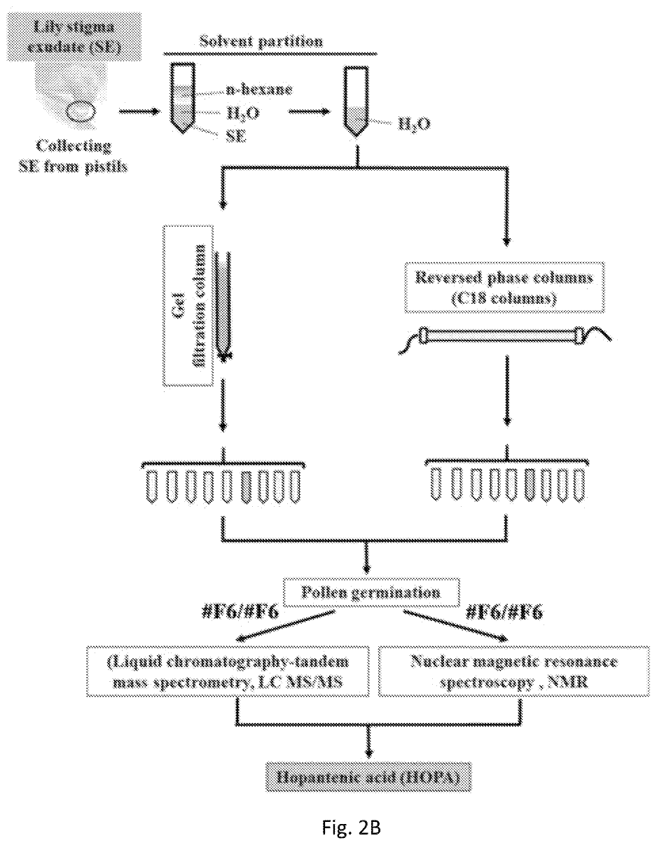

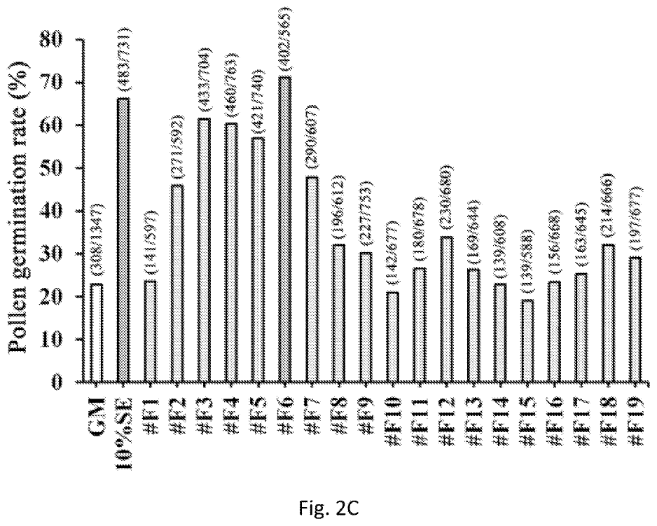

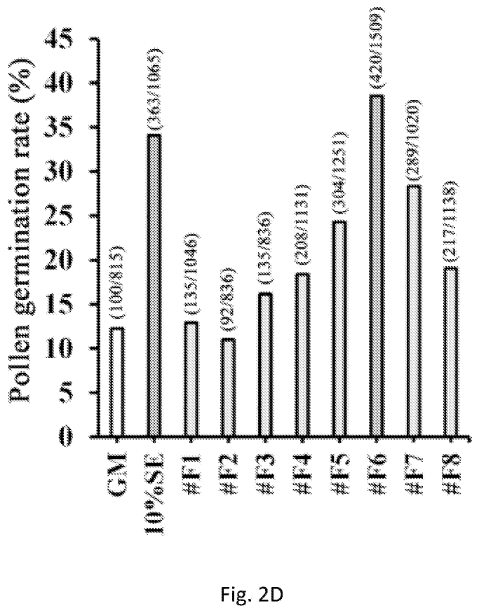

To isolate this putative exudate stimulating-germination component(s), we have collected the SE from L. longiflorum flowers and evaluated the optimal solubility of solvents used to extract the exudate stimulating-germination component(s) from SE. As shown in FIG. 2A, H₂O is the best solvent to completely dissolve the lyophilized/freeze-drying SE. To quantitively collect the SE for exudate stimulating-germination component(s) purification, the lily SE was collected from over 10,000 pistils, lyophilized, extracted by H₂O, and added n-hexane for partition. Discarding the organic layer, remained H₂O layer was submitted to the chromatography, and the separated fractions were collected (FIG. 2B). The collected fractions were subjected to pollen germination assay to identify which fraction(s) contained the putative exudate stimulating-germination component(s).

Pollen treated with fraction number 6 (#F6) collected from both gel filtration column (size-exclusion chromatography) or reversed-phase column (polar/non-polar chromatography) showed comparable effects to pollen germination to SE (FIGS. 2C-2D). Thence results suggest that #F6 might harbor exudate stimulating-germination component(s). Then, #F6 from the gel filtration column and the reversed-phase column was subjected to ultra-performance liquid chromatography-tandem mass spectrometer (UPLC MS/MS) and nuclear magnetic resonance spectroscopy (NMR) to reveal the identity of this promising exudate stimulating-germination component(s).

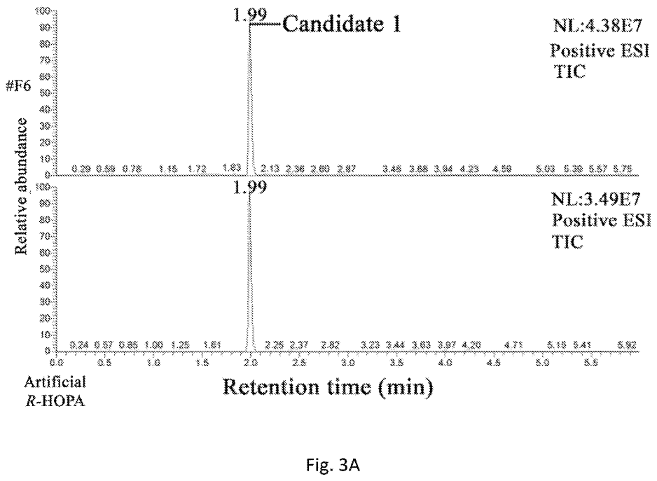

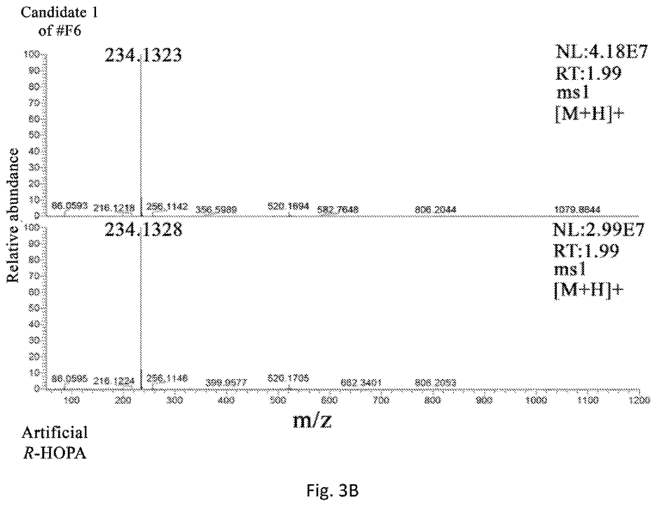

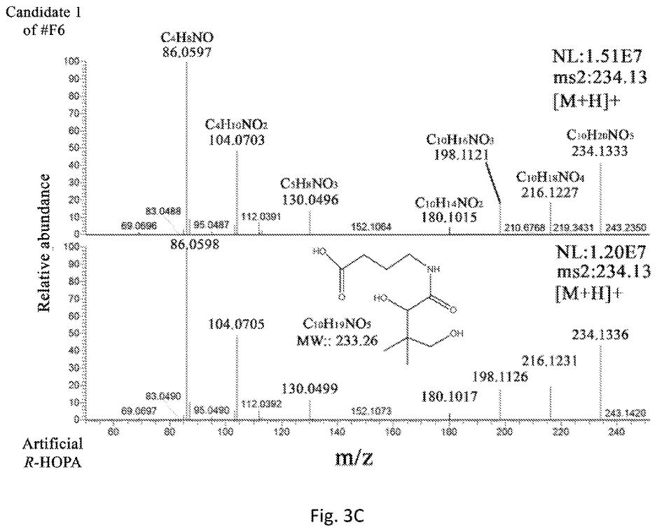

In the UPLC MS/MS result, there was one major peek detected in #F6 (FIG. 3A) with molecular mass 234.1323 g mol⁻¹ [M+H]+ in positive ionization mode (FIG. 3B).

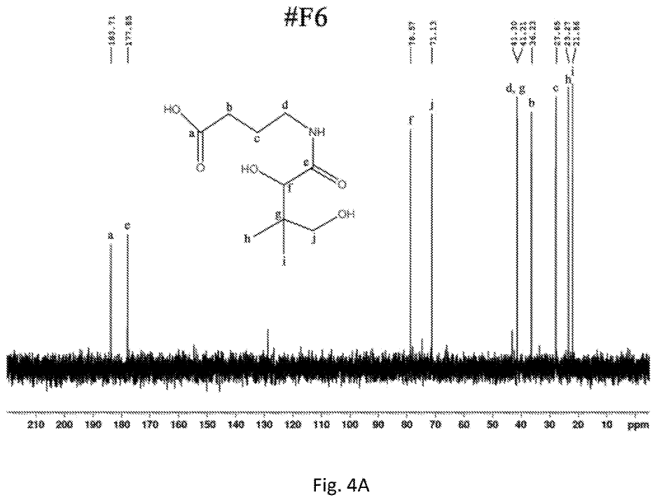

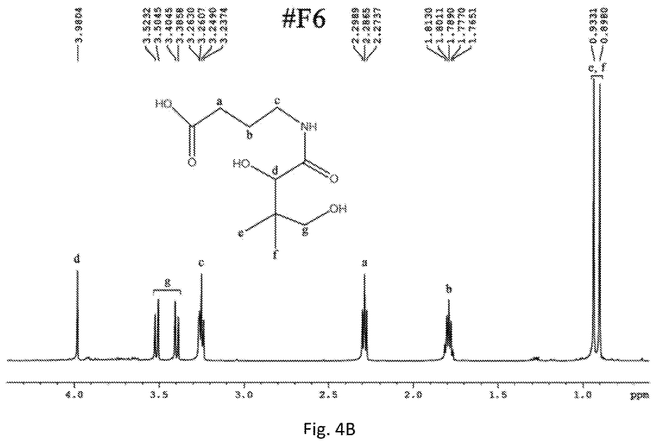

In the ¹³C NMR spectrum data, the characteristic signals show 13C NMR (125 MHz, D2O) d 183.7, 177.9 78.6, 71.1, 41.3, 41.2, 36.2, 27.7, 23.3, 21.9 (FIG. 4A); and the characteristic signals of ¹H NMR spectra show ¹H NMR (500 MHz, D2O) δ 3.98 (s, 1H, α-CH(OH))), 3.51 (d, J=10 Hz, CH₂OH), 3.40 (d, J=10 Hz, 1H, CH2OH), 3.25 (t, J=6.3 Hz, 2H, NCH2), 2.29 (t, J=6.4 Hz, 2H, α-CH2), 1.74-1.85 (m, 2H, β-CH₂), 0.93 (s, 3H, CH₃), 0.90 (s, 3H). The predicted molecular structure of Candidate 1 is C₁₀H₂O NO₅, which was determined by positive mode MS2 and supported by ¹³C and ¹H NMR assignments; those results revealed a predicted chemical structure of Candidate 1 (FIG. 3C, FIGS. 4A-4B).

To confirm that the predicted candidate 1, named hopantenic acid (HOPA), is the expected exudate stimulating-germination component, we synthesized it and used it for further biological assay. After working with a local chemical company (RDD LAB, Inc.), we successfully obtained the chemically synthesize candidate 1. The TIC (FIG. 3A), MS1 (FIG. 3B), and fragment-ion spectra fragment-ion spectra (FIG. 3C) results confirmed that HOPA is the primary candidate present in #F6 exhibiting stimulating pollen germination activity.

### 2.2 HOPA Significantly Boosts Easter Lily Pollen Germination

To validate the effect of HOPA on the stimulation of pollen germination, lily pollen grains were cultured in the GM containing 0, 10, 50, 100, and 200 ppm (part per million) of artificial HOPA for different time intervals. The pollen germination rates show a linear-gradient increase in a HOPA dosage-dependent manner. These results suggest that HOPA is lily SE's primary pollen germination stimulating component.

### 2.3 HOPA Significantly Rescued Germination Capability of Long-Time Storage and Heat-Damage Lily Pollen

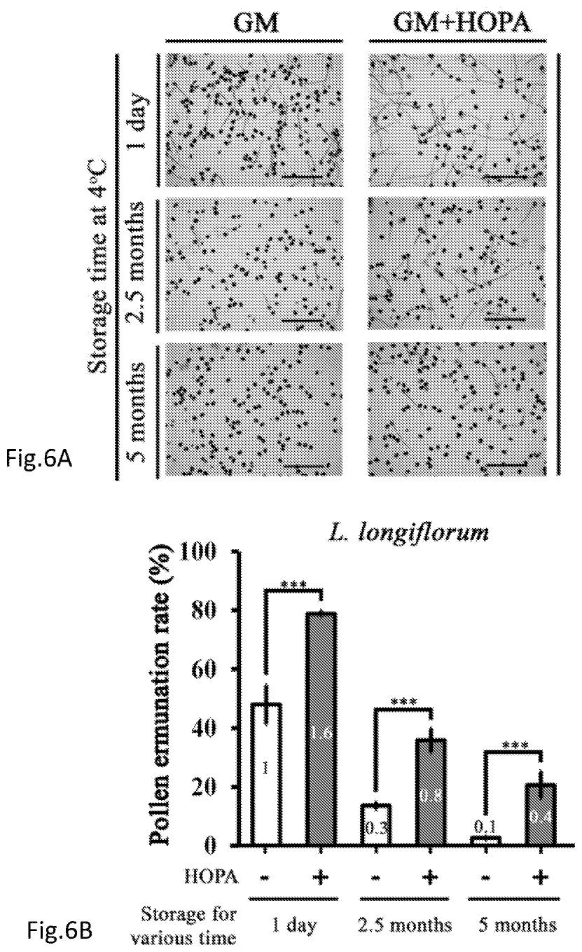

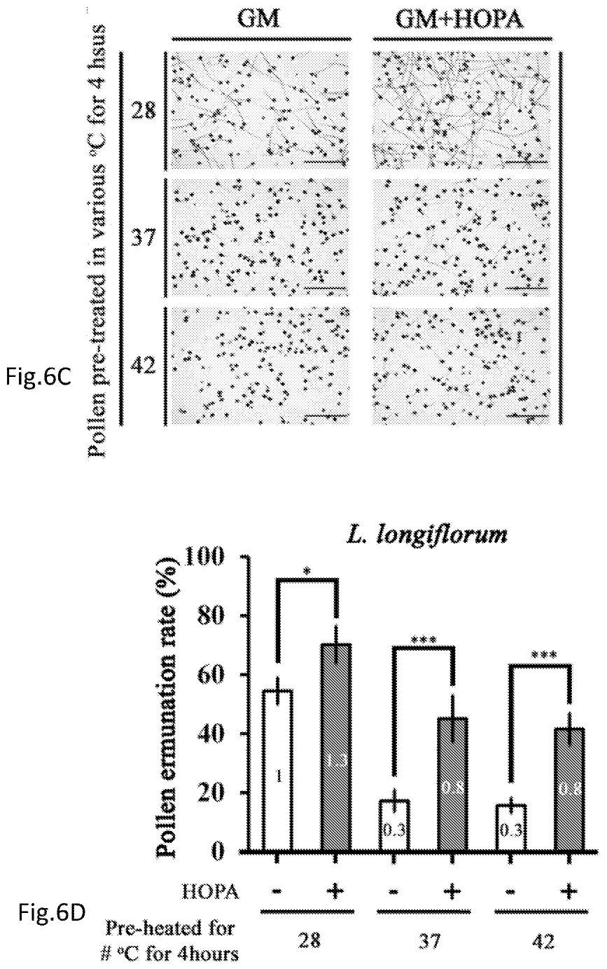

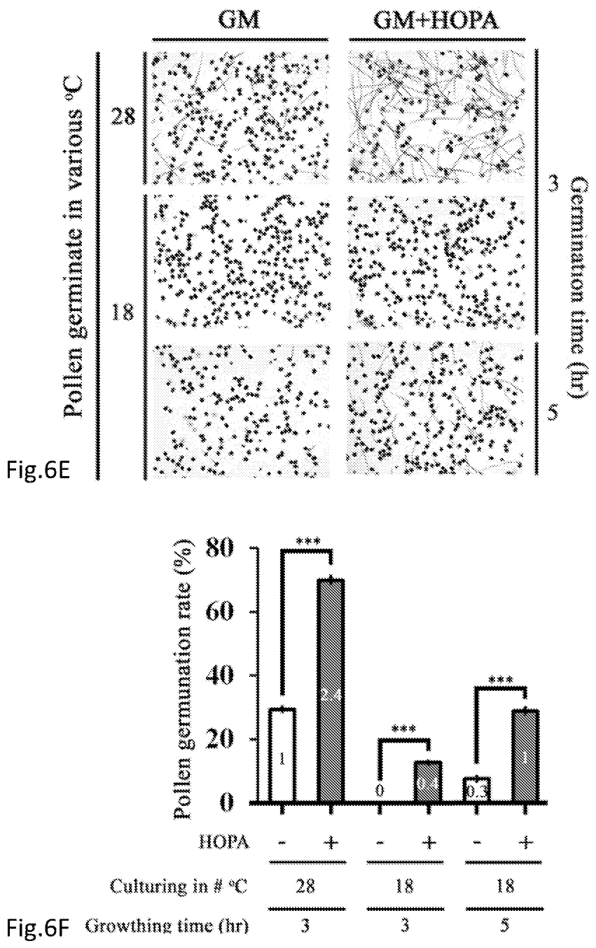

Pollen viability gradually decreased after long-time storage, even in low-temperature conditions (Mesnoua et al., 2018; Du et al., 2019). SE has shown its effect on restoring the lost germination capability of pollen stored at low temperatures for a specific period (FIGS. 1A-1E). To validate whether the purified HOPA is the cause to rescue pollen germination capability, pollen grains stored for different time intervals (1 day, 2.5, or 5 months) were subjected to germination assays with or without 100 ppm artificial HOPA present in the GM. Pollen germination rates showed a dramatic decrease after long-time storage. Nevertheless, HOPA treatment validly stimulates pollen germination in all stored pollen grains, especially for 5-month stored pollen germination compared with GM germinated pollen (FIGS. 6A-6B).

High temperature is an adverse factor for pollen viability (Rang et al., 2011). We further investigated the effect of HOPA on the restoration of pollen viability after heat damage. Freshly collected lily pollen were pre-heat treatments at 28, 37, and 42° C. for 4 hours, followed by subjecting for germination in the GM with or without HOPA at 28° C. for 2 hours. As expected, higher temperatures (37 and 42° C.) pre-treatments significantly retarded pollen germination; however, HOPA treatment compromised the heat stress causing a decrease in pollen germination (FIGS. 6C-6D).

Low temperature is another adverse factor for pollen germination and growth. Compared to pollen germinating at normal culture conditions (28° C.), the pollen germination rate was significantly eliminated at low-temperature conditions (18° C.). However, HOPA treatment partially rescued pollen germination rate at low-temperature conditions after 3-hour growth (FIGS. 6E-6F). For the control, about 8% of pollen was germinated after 3-hour culture, but HOPA rescued the pollen germination up to about 29% germination rate (FIGS. 6E-6F). These results demonstrate that HOPA is a promising regulator to recover pollen viability or to overcome the native predicaments of pollen, like native-low activity, being damaged by high temperature or growth at inappropriate low-temperature conditions.

### 2.4 HOPA Accelerates Pollen Tube Elongation

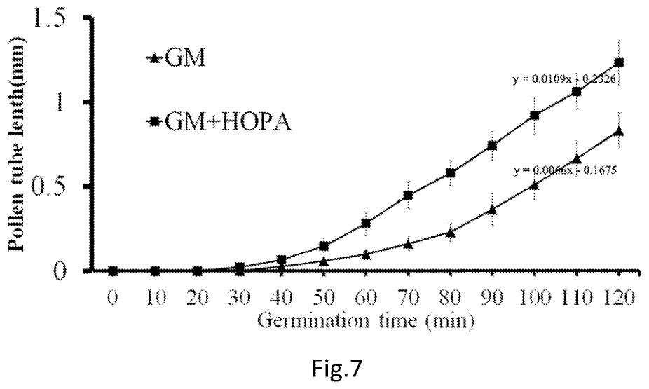

All these results demonstrate that HOPA can promote pollen germination; we further evaluated the effect of HOPA on pollen tube elongation. We germinated lily pollen in GM with or without 100 ppm HOPA at 28° C. for different time intervals to obtain their growth rates. Compared to control pollen germinated in the GM only (slope: 0.0066), HOPA treatment accelerated the pollen tube elongation rate (slope: 0.0109) (FIG. 7). These results highlight that HOPA can stimulate pollen germination and pollen tube elongation.

### 2.5 HOPA Performs Wide-Versatility on Pollen Germination

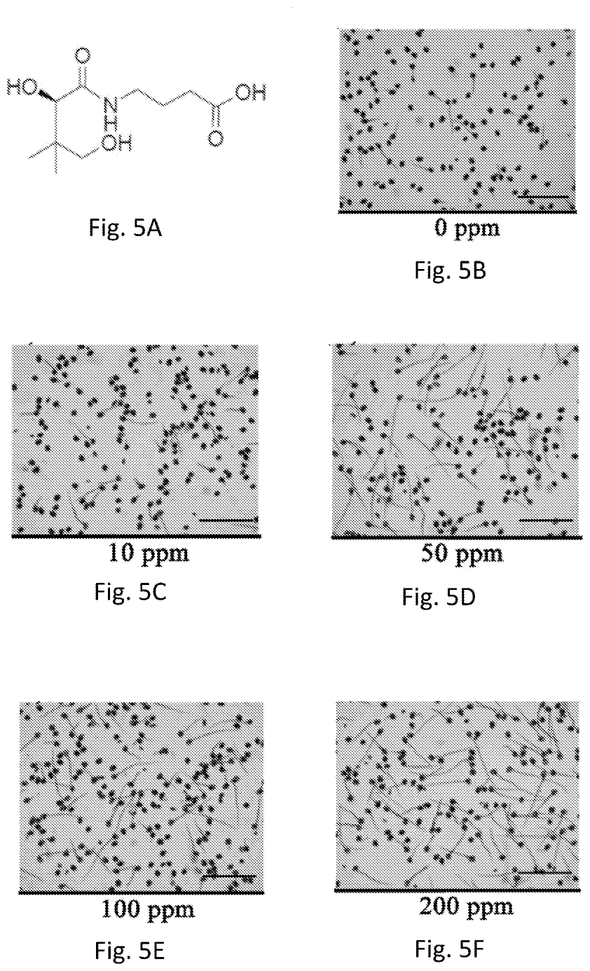

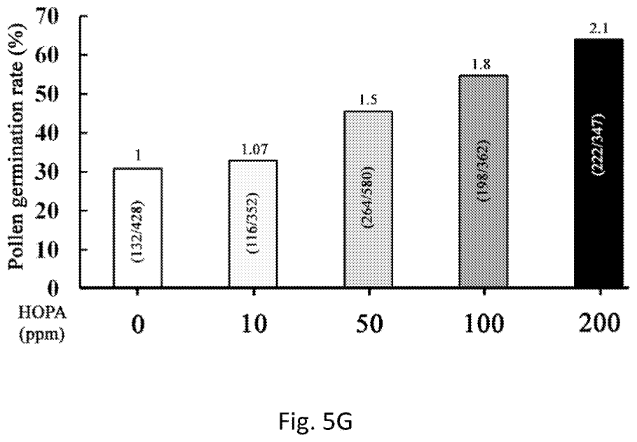

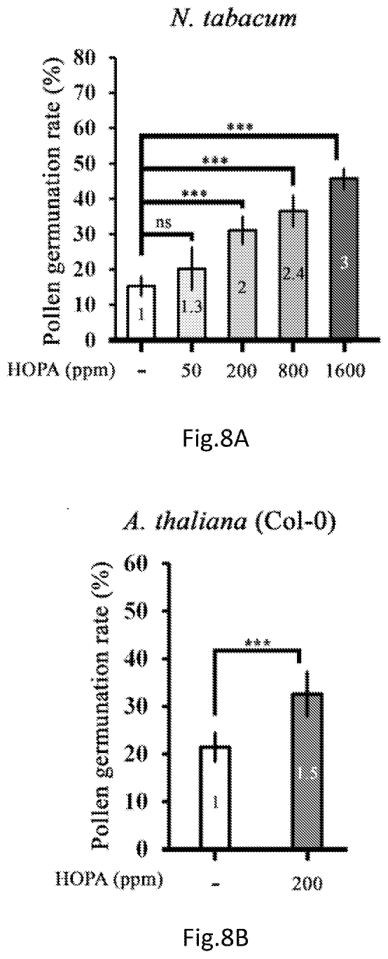

To investigate the possibility that HOPA can stimulate diverse-species pollen germination, we examined Nicotiana tabacum and Arabidopsis thaliana (Col-0) pollen in GM with or without HOPA at 25° C. for 2 hours. Similar to lily pollen (FIGS. 5A-5G), HOPA also significantly stimulated Nicotiana tabacum (FIG. 8A) and Arabidopsis thaliana pollen germination (FIG. 8B). Those results reveal the promising universal function of HOPA in stimulating pollen germination.

### 3. CONCLUSIONS

Various approaches to preserve pollen viability have been developed to overcome various flowering times or separate growth localization of cultivated germplasm lines, facilitate superior germplasm conservation, and help in supplementary pollinations used in devious breeding programs in vegetable crops. For example, low-temperature storage is the easiest and most common method to preserve pollen viability; however, pollen still gradually losses its activity even stored under low temperatures, such as −20° C. (Mesnoua et al., 2018; Du et al., 2019).

This study found that an exudate stimulating-germination component named HOPA significantly stimulated diverse-species pollen germination from 10 to 1600 ppm (FIGS. 5A-5G, FIGS. 8A-8B). Moreover, HOPA can rescue declined germination efficiency of long-time storage and heat-damaged pollen (FIGS. 6A-6F) and accelerate pollen tube elongation. Easter lily stigma secretes stigma exudate (SE) that contains about 7,854.8±659.08 ppm HOPA, but it is not feasible to collect and purify HOPA from fresh harvested SE at least due to time-consuming and low economic benefits. We have shown that 1/10 SE (v/v; containing about 785 ppm HOPA) stimulated Easter lily pollen germination (FIG. 1E); and surprisingly, a lower dosage of HOPA (such as 100-200 ppm; FIG. 5G) according to the present invention exhibits comparable effects in pollen germination rates. It will be interesting to explore the underlying mechanism of how HOPA participates in this germination activity restoration process. We believe that the results obtained from this study will significantly benefit pollen viability restoration used in the diverse breeding strategy of modern agriculture.

### REFERENCES

Du, G., Xu, J., Gao, C., Lu, J., Li, Q., Du, J., Lv, M., and Sun, X. (2019). Effect of low storage temperature on pollen viability of fifteen herbaceous peonies. Biotechnol Rep (Amst) 21, e00309.
Mesnoua, M., Roumani, M., and Salem, A. (2018). The effect of pollen storage temperatures on pollen viability, fruit set and fruit quality of six date palm cultivars. Scientia Horticulturae 236, 279-283.
Rang, Z. W., Jagadish, S. V. K., Zhou, Q. M., Craufurd, P. Q., and Heuer, S. (2011). Effect of high temperature and water stress on pollen germination and spikelet fertility in rice. Environmental and Experimental Botany 70, 58-65.

1. A method for enhancing pollen viability of plants comprising treating pollen grains of a flowering plant with a composition comprising an effective amount of a compound of Formula I 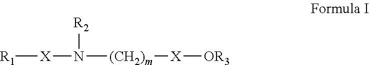
wherein
R₁, R₂, and R₃ are individually hydrogen, an alkyl group, an alkenyl group, an alkynyl group, an aryl group, a carboxyl group or a linear or branched hydrocarbon chain containing one or more hydroxyl groups;
X is —(C═O)—; and
m is an integer from 1 to 12.

2. The method of claim 1, wherein
R₁ is a linear or branched hydrocarbon chain containing one or more hydroxyl groups; and
R₂ and R₃ are individually hydrogen, an alkyl group, an alkenyl group, an alkynyl group, or an aryl group.

3. The method of claim 1, wherein
R₁ is represented by —CHOH-L-CH₂OH, wherein L is an alkylene group with a linear or branched chain.

4. The method of claim 3, wherein L is represented by —(CRₐR_{b})ₙ—, in which n is an integer from 1 to 12, and each of Rₐ and R_{b} is individually hydrogen or an alkyl group.

5. The method of claim 1, wherein R₁ is represented by Formula Ia 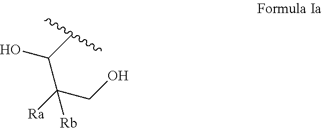
wherein Rₐ and R_{b} are individually hydrogen or an alkyl group.

6. The method of claim 1, wherein the compound is represented by formula (1)

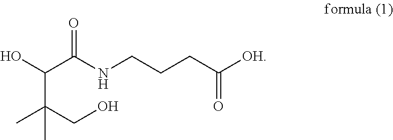 [SMILES: CC(C)(CO)C(O)C(=O)NCCCC(=O)O]

7. The method of claim 6, wherein the compound includes

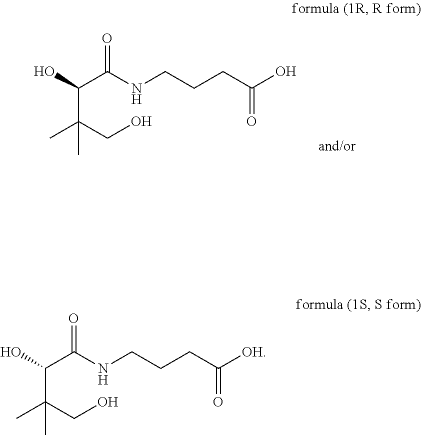 [SMILES: CC(C)(CO)[C@@H](O)C(=O)NCCCC(=O)O ; CC(C)(CO)[C@H](O)C(=O)NCCCC(=O)O]

8. The method of claim 1, wherein the compound of Formula I is present in the composition of concentration ranging from 1 to 2,000 ppm.

9. The method of claim 1, wherein the composition comprises a pollen germination medium containing an osmotic component, minerals, a buffer component, and water.

10. The method of claim 1, wherein the composition comprises 1 to 2,000 ppm of the compound of Formula I and 0.5-20 mM CaCl₂, 0.1-5 mM H₃BO₃, 0.9-20 mM KNO₃, 1-5 mM Ca(NO₃)₂·4H₂O, 0.5-5 mM MgSO₄·7H₂O or KCl, and/or 3-20% sucrose or 2-20% PEG 4000; and/or 5-20 mM MES, 10-40 μM CuSO₄ and/or 1-20 mM MgSO₄.

11. The method of claim 1, wherein the composition is an aqueous or a powdered composition.

12. The method of claim 11, wherein the pollen grains are cultured in the aqueous composition.

13. The method of claim 1, wherein the pollen grains are subjected to storage and/or heat damage before the treatment with the composition.

14. The method of claim 1, wherein the pollen grains are cultured in the aqueous composition at a temperature of 25 to 28° C.

15. The method of claim 1, wherein the pollen grains are cultured in the aqueous composition at a temperature of 10 to 20° C.

16. The method of claim 1, wherein the amount of the compound of Formula I is effective in promoting pollen germination and pollen tube growth.

17. The method of claim 1, wherein the flowering plant is selected from the group consisting of rice, wheat, barley, oat, corn, arabidopsis, cabbage, tomato, cucumber, pumpkin, tobacco, cotton, sugar beet, chrysanthemum, lily, rose and tulip.

18. Use a compound of Formula I as defined in claim 1 for manufacturing a composition for enhancing the pollen viability of a flowering plant.

19. A compound of Formula I as defined in claim 1 for use in enhancing pollen viability of a flowering plant.

20. A composition comprising a compound of Formula I as defined in claim 1 and an excipient, wherein the compound is present in an amount effective in promoting pollen viability of a flowering plant.

21. The composition of claim 20, wherein the amount of the compound is from 1 to 2,000 ppm.

22. The composition of claim 20, wherein the composition comprises a pollen germination medium containing an osmotic component, minerals, a buffer component, and water.

23. The composition of claim 20, wherein the composition comprises 1 to 2,000 ppm of the compound of Formula I and 0.5-20 mM CaCl₂, 0.1-5 mM H₃BO₃, 0.9-20 mM KNO₃, 1-5 mM Ca(NO₃)₂·4H₂O, 0.5-5 mM MgSO₄·7H₂O or KCl, and/or 3-20% sucrose or 2-20% PEG 4000; and/or 5-20 mM MES, 10-40 μM CuSO₄ and/or 1-20 mM MgSO₄.

24. The composition of claim 20, wherein the composition is an aqueous or a powdered composition.
